(19) United States
(12) Patent Application Publication
(10) Pub. No.: US 2002/0112833 A1
(43) Pub. Date: Aug. 22, 2002

(54) Security paper

(76) Inventors: Luciano Beghello, Huddinge (SE); Martti Toivakka, Oberanven (LU)

Correspondence Address: BANNER & WITCOFF, 1001 G STREET N W, SUITE 1100, WASHINGTON, DC, 20001, US

(21) Appl. No.: 09/861,851

(22) Filed: May 22, 2001

(30) Foreign Application Priority Data
Feb. 19, 2001 (SE) 0100551-1

(51) Int. Cl. D21H 21/40; B42D 15/00; D21H 21/48; D21H 17/33; D21H 17/55; G06K 5/00

(52) U.S. Cl. 162/140; 162/164.1; 162/168.1; 162/158; 283/83; 283/72; 283/57

(57) ABSTRACT

A novel substrate for the manufacture of security documents, said substrate comprising conductive polymer particles.

The present invention concerns security paper, or paper for use in the manufacture of security documents, such as bank notes, passports, lottery tickets and other documents, the authenticity of which is of great importance and needs to be readily verified. The invention also concerns a method for the verification of the authenticity of such paper.

### BACKGROUND OF THE INVENTION

The availability of advanced photocopying machines, computer software for graphic design, and advanced printing equipment has made it easier to replicate valuable documents, such as bank notes, traveller's cheques, bank cheques, passports, identity documents and driving licenses, to mention a few examples. Consequently there is a demand for methods for protecting documents against forgery, including security features to be incorporated on or even into the substrate used for said valuable documents.

When considering security features, it should be noted that there is a demand for primary features, that is security features, which are easily identified without the aid of special equipment, as well as secondary security features, or features identified only through a closer study of the document. Primary security features include water marks, tactile details, micro text, holograms and similar features, readily discernible by an average user. Secondary features include fluorescence, e.g. UV-fluorescence, conductivity, reflectance, magnetic properties etc, possible to determine only using suitable apparatus. The detection of secondary security features can be done by automatic measurements, which can be performed without human contribution, thereby possible to be incorporated in vending machines, exchange automates, automatic telling machines etc.

### PRIOR ART

The present use of security threads in bank notes provides simultaneously both a primary and a secondary security feature. The security threads used for this purpose are predominantly cut from metal-coated, printed, dyed or pigmented plastic films. The primary security feature consists of the mere existence of a thread in the paper. This is due to the fact that the thread is almost invisible in incident light, but clearly visible in transmitted light. This is a feature difficult to imitate by a print on the paper. Further primary features consist of symbols, printed either in negative or positive print, and visible to the naked eye.

Security threads are however not without their problems. This widely used, although rather expensive security element is susceptible to breaking or cracking, and thus loosing its characteristic conductivity. Lately, also incidences of corrosion of the metal layer in security threads has been reported. It is believed that the corrosion is due to chemical reactions between the metal containing ink or magetic layer, often containing iron, and the thin conductive layer, often consisting of aluminum.

It is known to mix polymer fibres in the paper pulp in order to improve the strength of paper. In the same spirit, U.S. Pat. No. 5,868,902 teaches a method of coating paper with a coating comprising an unpigmented polyurethane. The unpigmented polyurethane may optionally comprise a functional additive provided that the presence of the functional additive does not increase the opacity of the paper by more than 1%. The examples of functional additives given in U.S. Pat. No. 5,868,902 are fluorescent and iridescent additives, such as fluorescent and iridescent pigments, and magnetic particles. The coating must be substantially transparent and it is underlined, that the coatings do not markedly alter the feel or appearance of the paper.

A method for the manufacture of paper with visible, continuous streaks and/or delimited fields is disclosed in U.S. Pat. No. 5,989,389. The teaching of this patent includes the use of synthetic polymers, such as polyvinyle alcohol fibres, acrylic fibres, and diacetate fibres. The streaks or fields according to U.S. Pat. No. 5,989,389 constitute typical primary security feartures.

The objective of the present invention is to integrate one or several security features, primary and/or secondary, in the substrate or paper itself. Further objectives include the improvment of the durability of the security features, lowering the production costs with maintained security standards and simplifying production.

### SUMMARY OF THE INVENTION

The present inventors have surprisingly shown that the addition of electrically conductive polymer particles in or on the substrate used for the production of security documents, offers a good solution to the above shortcomings of the prior art. The invention is defined in the attached independent and dependent claims, incorporated herein by reference.

### SHORT DESCRIPTION OF THE DRAWINGS

The invention will be disclosed in further detail in the description, non-limiting examples and claims, and illustrated in the attached drawings, in which

FIG. 1 shows a schematic view of a bank note in transmitted light, showing the presence of a watermark 1 and a vertical streak 2 of electrically conductive polymers blended into the paper substrate 3.

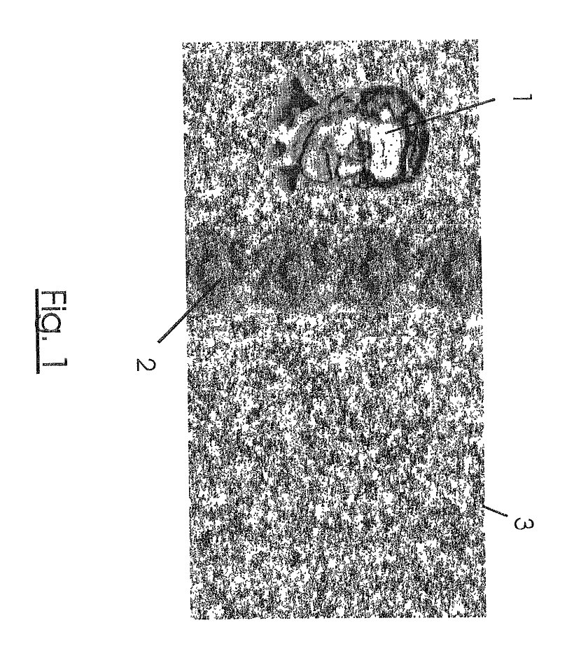

### DESCRIPTION

The terms “paper” and “substrate” are used herein to encompass all types of sheets of fibrous and/or polymer materials, used for the production of security documents, such as bank notes, identity documents, driver's licences, lottery tickets, entrance tickes, travel documents, tickets, passports, cheques, seals etc.

Paper is a material traditionally associated with high resistivity or low conductivity. As an example it can be mentioned that paper has been used as insulation in electric applications, for example in cables. The resistivity of paper is in the interval of about 10¹¹-10¹⁴ Ohm cm and the corresponding conductivity in the interval of about 10⁻¹¹-10⁻¹⁴ S/cm.

The terms “fibres” and “fibres” are used herein in their broadest meaning, encompassing elongated particles in general, regardless of their origin, that is regardless of these fibres/particles being of organic or inorganic, synthetic or natural origin.

The terms “conductivity” and “resistivity” are used alternately, as a material having low conductivity also has high resistivity and vice versa.

Polymers have traditionally been considered to have low electrical conductivity. Attempts to increase the conductivity of polymers has comprised the addition of conductive fillers, such as carbon blacks, metal particles and flakes, metal fibres, carbon fibres and the like. A new class of organic polymers capable of conducting electricity has however recently been developed. These polymers become conductive upon partial oxidation or reduction, a process commonly referred to as doping.

Suitable polymers for use according to the present invention are conductive polymers exhibiting a conductivity in the range of about 10⁻¹⁰ to 10² S/cm, either alone or blended with commercially available so called commodity polymers. One example is the group of polyaniline polymers, e.g. Panipol® (Panipol Ltd., Porvoo, Finland), and these polymers can be used as such, or blended with polyester, polyethylene, polypropylene, polystyrene, PVC, phenol formaldehyde resins, and different types of thermoplastic elastomers.

Another example is the polymer known as PEDOT (Poly[ethylenedioxythiophene]) which can reach an electrical conductivity of about 10⁴ S/m. Depending on the desired properties, such as strength, PEDOT may have to be blended with other polymers, for example added to a matrix of polymers such as polyester, polyethylene, polypropylene, polystyrene, PVC, phenol formaldehyde resins, and different types of thermoplastic elastomers.

Another example are conductive polymers based on the EDT-monomer or 3,4-ethylenedioxythiophene (known as Baytron M™ or EDT, from Bayer Corporation Electronic Chemicals, Pittsburgh, USA). The conductive polymer poly-3,4-etylenedioxythiophene-polystyrenesulfonate (known as Baytron P™ or PEDT/PSS, from Bayer Corporation Electronic Chemicals, Pittsburgh, USA) is also available as an aqueous dispersion. This dispersion can be used as the conductive ingredient in coating formulations to impart local or global conductivity on a surface (surface resistance 10² Ohm or higher).

According to one embodiment, the present invention provides a substrate for the manufacture of security documents, said substrate being based on cellulose fibres, including cotton and/or rayon fibres, and comprising conductive polymer particles chosen from the group comprising polyaniline polymers, polyanliline polymers blended with polyester, polyethylene, polypropylene, polystyrene, PVC, phenol formaldehyde resins, and thermoplastic elastomers.

The strength and functional properties of the polymer material to be processed into particles, in particular fibres, for incorporation in the paper stuff according to the present invention can be modified by the addition of pigments and/or fillers. The above mentioned polymers make it possible to manufacture electrically conductive, coloured and, if desired, transparent fibres. If desired, the fibres can be given magnetic properties or optical properties, e.g. fluorescent colour in order to add security features to the paper.

According to one embodiment of the invention, the conductive polymer fibres are blended evenly in the paper stuff before formation of the sheets. Alternatively, the conductive polymer can be added in delimited areas or fields, running in the machine direction or in transverse direction, preferably in machine direction.

The conductive polymer can also, according to one embodiment of the invention, be added to the surface of the paper or the substrate in question, for example in the form of a thin film, either evenly over the area of the paper, or locally, on specific delimited areas. A pattern of conductive polymer material or materials can also be arranged in or on the substrate. When a pattern of conductive polymer material is arranged on the surface, this can be done using conventional or modified printing methods, e g using an aqueous dispersion of the conductive polymer. Conductivity measurements at various points would then give different readings and a novel security feature is achieved.

According to one embodiment of the invention, transparent conductive polymer materials are used. The polymers may be added locally to a specific area/in a specific pattern or added evenly to the entire area of the substrate. When using coloured or opaque particles or fibres, these are preferably arranged locally or only to parts of the substrate, destined to become covered with other elements, e.g. printed over.

According to another embodiment of the invention, the conductive polymer fibres are added in the form of continuous streaks and/or delimited fields in conjunction with forming the paper web in a paper machine, for example according to the method described in U.S. Pat. No. 5,989,389. Depending on the choice of polymer blend, fillers and binders added, it is possible to produce streaks or field with an optically different character compared to the surrounding paper, for example more translucent or transparent than the surrounding paper, in addition to exhibiting electrical conductivity. In this embodiment, both a primary and a secondary security feature will thus be present.

According to yet a further embodimetn of the invention, magnetic particles are added to the paper, in addition to the conductive polymer particles. The magnetic particles can be mixed evenly in or on the substrate or added to specific areas or in specific patterns. The magnetic particles can be formed by coating conductive polymer particles with a magnetic substance.

The present invention also provides a method for the verification of the authenticity of security documents manufactured using a substrate comprising conductive polymer particles, wherein that the conductivity of said substrate is measured over at least a fraction of the length of the security document. Preferably the conductivity of the substrate is measured in two steps, a first step of measuring the conductivity along a first dimension of the security document, and thereby locating the position of a streak comprising conductive polymers, and a second step of measuring the conductivity along a second dimension of the security document, said second dimension being at right angles to said first dimension.

The inventive method is further improved when magnetic particles are present in the substrate, and the presence or absence of magnetic particles in the substrate is determined. Preferably the location of magentic particles and/or the magnetic properties of said particles is determined in order to obtain a more complex identity or profile of the security document.

An advantage of conductive polymers is the directional anisotropy of conductivity, which enables the differentiation between the direction of the security element, thereby adding yet another secondary security feature.

Although the invention has been described with regard to its preferred embodiments, which constitute the best mode presently known to the inventors, it should be understood that various changes and modifications as would be obvious to one having the ordinary skill in this art may be made without departing from the scope of the invention as set forth in the claims appended hereto.

1. Substrate for the manufacture of security documents, characterized in that said substrate comprises conductive polymers.

2. Substrate according to claim 1, characterized in that said conductive polymers are evenly distributed in the substrate.

3. Substrate according to claim 1, characterized in that said conductive polymers are added to the surface the substrate.

4. Substrate according to claim 1, characterized in that said conductive polymers are distributed along delimited streaks in the substrate.

5. Substrate according to claim 1, characterized in that said conductive polymers are printed on the surface of the substrate.

6. Substrate according to any one of claims 1-5, characterized in that said polymers are chosen from the group comprising polyaniline polymers, polyanliline polymers blended with polyester, polyethylene, polypropylene, polystyrene, PVC, phenol formaldehyde resins, and thermoplastic elastomers.

7. Substrate according to any one of claims 1-5, characterized in that said substrate comprises magnetic particles.

8. Substrate for the manufacture of security documents, characterized in that said substrate is based on cellulose fibres and comprises conductive polymer particles chosen from the group comprising polyaniline polymers, polyanliline polymers blended with polyester, polyethylene, polypropylene, polystyrene, PVC, phenol formaldehyde resins, and thermoplastic elastomers.

9. Security document, characterized in that said document is manufactured using a substrate according to any one of claims 1-7.

10. Security document, characterized in that said document is manufactured using a substrate according to claim 8.

11. Bank note, characterized in that said bank note is manufactured from a substrate according to any one of claims 1-7.

12. Bank note, characterized in that said bank note is manufactured from a substrate according to claim 8.

13. Method for the verification of the authenticity of security documents manufactured using a substrate comprising conductive polymer particles, characterized in that the conductivity of said substrate is measured over at least a fraction of the length of the security document.

14. Method for the verification of the authenticity of security documents according to claim 13, characterized in that the conductivity of the substrate is measured in two steps, a first step of measuring the conductivity along a first dimension of the security document, and thereby locating the position of a streak comprising conductive polymers, and a second step of measuring the conductivity along a second dimension of the security document, said second dimension being at right angles to said first dimension.

15. Method for the verification of the authenticity of security documents according to claim 13, characterized in that the presence or absence of magnetic particles in the substrate is determined.

16. Method for the verification of the authenticity of security documents according to claim 13, characterized in that the location of magentic particles and/or the magnetic properties of said particles are determined.
